(19) United States
(12) Patent Application Publication
(10) Pub. No.: US 2005/0220439 A1
(43) Pub. Date: Oct. 6, 2005

(54) Interactive multimedia system and method

(76) Inventors: Owen A. Carton, Hillsborough, CA (US); Martha C. Serrano, Hillsborough, CA (US)

Correspondence Address: CLOCK TOWER LAW GROUP, 2 CLOCK TOWER PLACE, SUITE 255, MAYNARD, MA, 01754-2545, US

(21) Appl. No.: 11/084,268

(22) Filed: Mar. 18, 2005

Related U.S. Application Data
(60) Provisional application No. 60/554,608, filed on Mar. 19, 2004.
(60) Provisional application No. 60/572,538, filed on May 19, 2004.

(51) Int. Cl. H04N 9/74

(52) U.S. Cl. 386/4

(57) ABSTRACT

A method of authoring a DVD with indexed promotional and informational content; a system for delivering indexed promotional and informational content for video scenes streamed from a DVD disc or a PVR; and a system for accessing this promotional and informational content via a remote control, a computer input device, or the fascia buttons of DVD players, thereby providing viewers with reference information regarding all scene content, providing video feature producers and advertising agencies with new advertising options to sell to advertisers, and providing video feature directors with a new channel for delivering additional content features for the purpose of entertainment, information, or education.

### CROSS REFERENCE TO RELATED APPLICATIONS

This utility patent application claims priority from 1) U.S. provisional patent application Ser. No. 60/554,608, filed Mar. 19, 2004, titled “INTERACTIVE DVD SYSTEM AND METHOD” in the name of Owen A. Carton and Dr. Martha C. Serrano and 2) U.S. provisional patent application Ser. No. 60/572,538, filed May 19, 2004, titled “INTERACTIVE MULTIMEDIA SYSTEM AND METHOD” in the name of Owen A. Carton and Dr. Martha C. Serrano.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Copyright 2004-2005 TellX.

### BACKGROUND OF THE INVENTION

1. Field of the Invention

This invention relates generally to interactive multimedia systems. This invention relates more specifically to interactive multimedia systems employing DVDs, which are sometimes called Digital Video Discs or Digital Versatile Discs.

This invention relates more specifically to systems capable of containing, displaying, or streaming digital video content.

2. Description of Prior Art

Video producers who produce any type of video content, including, but not limited to, DVDs, motion pictures, video tapes, broadcast television, cable television, pay-per-view or on-demand video, music videos, and video magazines, have always looked for multiple ways to generate revenue from their works. Revenue is generated from a combination of licensing, advertising, user fees, rental fees, and otherwise.

For example, one type of video feature is a motion picture, and the follow discussion uses motion pictures as an example but applies to any type of video feature. Motion picture (movie) producers have always looked for multiple ways to generate revenue from motion pictures. In the “lifetime” of a motion picture, this may include licensing the motion picture for display in movie theaters, then producing DVDs for rent or sale in retail establishments, and then licensing the motion picture for broadcast on network or cable television stations. Producers may also decide to re-release their movies on DVDs with special additional features and extras in the hope of generating incremental sales revenue from the sales of DVDs to enthusiasts of the video content above what the regular DVD release may have generated. In addition, motion picture producers can generate revenue by including advertising before, after, or during the motion picture. In movie theaters, advertising typically takes the form of previews or trailers shown before the start of a movie. In television broadcasts, advertising in the form of commercials is typically displayed periodically during the motion picture.

DVD advertising has generally followed the movie theater model where advertisements are placed before the start of the movie or in the form of credits after the end of the movie. In addition, product placement opportunities exist for advertisers to showcase their products. For example, in the movie “E.T. The Extraterrestrial,” E.T.'s favorite food is Reeses Pieces, a product placement opportunity originally offered to M&M Mars company.

With DVDs, the problem with placing advertising before or after a movie is that DVDs are typically viewed in a home setting where viewers are more likely to get up from their seats than if they were in a movie theater. Another problem with product placement in movies is that, because of the subtlety of the product placement, the advertiser is relying on the viewer remembering the brand name of the product that was placed in the motion picture. Another problem is that the viewer may not be able to read the brand name easily or at all, and to compensate for this, a movie director may need to modify the script or story line significantly to help draw attention to the product or brand, thereby potentially compromising the entertainment value of the movie. Another problem is that viewers might be interested in more products and services than those that advertisers have placed in the movie. For those products, viewers must rely on the Internet or other unofficial sources of information to find out, for example, what glasses an actress was wearing, the name of a restaurant where a couple was dining, or the name of a song that was playing in the background.

The prior art includes efforts to solve some of these problems.

There are examples of DVD-hosted movies (such as “The Matrix”) that include viewer-visible cues contained within the frame of the movie. The viewer is able to point to and select these cues to invoke a sub-menu as defined in the authoring process. There are two problems with this approach. First, visible cues are distracting to the overall enjoyment of the movie and the average viewer would reject their inclusion. Second, this method of invoking a sub-menu provides no reliable means to return to the movie at the location that the viewer was watching before selecting the visible cue.

The prior art also includes patent documents, which are discussed in detail below.

U.S. Pat. No. 6,564,255 “Method and apparatus for enabling internet access with DVD bitstream content” (Mobini et al. May 13, 2003) discloses, in the Abstract, “An interactive DVD browser in accordance with the DVD specification for read-only discs is capable of accessing remotely located data over the Internet through a technique which contemplates new navigation commands as well as the embedding of HTML page addresses in navigation commands in place of data stream identifiers currently unused by the DVD specification. A navigation command is supplied to the interactive DVD browser indicating the browser should change data sources. The navigation command includes a network protocol address, in the form of HTML page address, as well as a local address of the user's default Internet browser. A second command specifies a predetermined period of time in which the browser should wait until the Internet browser establishes a hyperlink to the remote source of presentation data specified by the network page address. If the data resident at the specified address is suitable for presentation by the DVD browser, the data is presented, otherwise, the DVD browser will wait while the network browser presents non-DVD compliant data. The technique enables software updates, on-line registration and other dynamic data activities to occur with a legacy DVD browser while still complying with the DVD specification for read-only disc.”

The Mobini patent refers to a browser technology that requires a personal computer to interpret browser-specific HTML code on a DVD in order to access related data over the Internet, thereby combining both the local data from the DVD with the data from the Internet server. The preferred embodiment of the present invention, on the other hand, does not require a browser to operate nor does it require a personal computer to access information stored remotely on the Internet or locally on the DVD video media itself. The present invention provides complete access to relevant data stored on the DVD using the capabilities of a DVD player alone.

U.S. Pat. No. 6,574,424 “Method and apparatus for a randomizer for DVD video” (Dimitri et al. Jun. 03, 2003) discloses, in the Abstract, “A bit is provided in each Digital Video disc memory sector header to indicate the type of information contained in the main data portion of the frame. A vector of video clips are stored on the DVD disc and the DVD drive examines the bit to determine whether to play a movie or to employ logic provided by the present invention that allows the DVD drive to determine which included video clip to play instead. The video clips may include cartoons, commercials, movie previews, etc. and the logic employed by the DVD drive allows for random or specific selections to be played at predetermined times, such as displaying a clip during the flipping process of a dual-sided DVD disc. Additionally, the method and apparatus may be applied to DVD discs to determine whether commercials are played before, after or during the movie or the movie is played commercial free.”

The present invention does not require a specialized sector of the DVD to be allocated for its own use as the Dimitri patent mandates. Unlike the Dimitri patent, in the present invention, there is no predetermination by the disc content author whether or not a viewer will see a commercial or promotion of some sort during playback of the DVD. It is the choice of the viewer as to whether or not they wish to see promotional content, and the display of that content is controlled by the viewer, not by logic pre-authored onto the DVD. The present invention does not require any specialized apparatus to run and present promotional information, nor does it load “firmware” or “computer programs” from the DVD as referenced in the Dimitri patent.

U.S. Pat. No. 6,654,547 “DVD rental system and method” (Maeda et al. Nov. 25, 2003) discloses, in the Abstract, “A digital versatile disc (DVD) includes a read-only ROM area in which video is previously recorded, and a readable/writable RAM area. A lender DVD apparatus writes a playback/recording control program in the RAM area of the DVD to be rented. A user DVD apparatus reads the playback/recording control program from the RAM area of the rented DVD. Following the playback/recording control program, the user DVD apparatus receives digital broadcasting, extracts commercial messages therefrom, and writes the extracted commercial messages in the RAM area. Then, the user DVD apparatus reads the video from the ROM area and the commercial messages from the RAM area for playback. Then, the user DVD apparatus generates history data indicating how many times and which commercial message has been played-back, and writes the generated history data in the RAM area.”

The Maeda patent refers to an apparatus for both DVD video lenders and an apparatus for DVD video users whereby the proprietary apparatus “writes” consumer viewing habits to specific sectors of DVD RAM so that the lenders can read and analyze which commercials the user is viewing on the DVD after it is returned to the lender. The Maeda patent also refers to a method by which broadcast advertisements can be accessed by the user apparatus to play during playback of the DVD content. The Maeda patent differs from the present invention in that the present invention does not use or require any proprietary lender or user DVD apparatus to provide viewers with access to promotional content on the DVD video disc. The present invention does not need to store users' viewing habits on the media itself or require the user to have access to broadcast signals for commercials from cable, satellite, or other sources beyond the content of the DVD itself. With the present invention, all of the promotional content is stored on the DVD and accessed using standard DVD players without modification.

U.S. patent application Ser. No. 20040019521 “System and method for advertising products and services on computer readable removable medium” (Birmingham Jan. 29, 2004) discloses, in the Abstract, “A system, method and computer-readable removable medium for advertising products and services is disclosed. In an embodiment of the present invention, the computer-readable removable medium includes computer instructions for providing metadata associated with establishments located in a predefined geographical area that sell products and services. The computer-readable medium includes metadata associated with establishments that pay to be listed and establishments that do not pay to be listed. The computer-readable removable medium further includes computer instructions for searching establishments by name, type and location. The computer-readable removable medium further includes coupons for discounted products or services at the establishments that are listed. The computer-readable removable medium is a Compact Disc (CD) or a Digital Versatile Disc (DVD). In addition, the advertised establishments are any one of restaurants, hotels, movie theaters, nightclubs, retail shops and theme parks.”

The Birmingham patent application refers to a method by which computer readable media, such as CDs or DVDs, includes meta-data to provide a viewer with the ability to search for specific goods or services in a geographically suitable region, whereby the computer readable media acts as an interactive directory of these goods and services. The DVD/CD computer readable media content can also be merged with data from an Internet connection. The present invention differs from the Birmingham patent application in that the invention does not require a computer for the user or viewer of a DVD to search for and view promotional content nor does it require or need access to the Internet to provide additional related information.

None of the above provides an interactive DVD system that 1) can be implemented on a DVD player without requiring a computer or Internet connection, 2) includes both the video feature and the promotional content on the same DVD and 3) allows a viewer to pause a video feature, browse information, and return to the spot in the video feature where the viewer left off. What is needed, therefore, is an interactive DVD system that overcomes the above-mentioned limitations and that includes the features enumerated above.

### BRIEF SUMMARY OF THE INVENTION

With the invention, a viewer of a DVD can graphically navigate to and directly interrogate on-screen icons, which provide additional reference information regarding scene content or audio track references for the purposes of promotion, advertising, or education. For example, with a commercial set-top DVD player, a viewer can graphically navigate to and directly interrogate on-screen icons using a DVD remote control or equivalent buttons on the set-top box. The DVD player can be a set-top DVD player, a stand-alone DVD player, a DVD player emulated by computer, or any other device that plays DVDs according to the DVD specification.

Important to the operation of the invention are three classes of data: Video Content, Metadata, and Index. Video Content includes the video data, such as a movie, sporting event, music video, video magazine, or any other video feature. The Metadata includes the promotional content. The Index associates promotional content with each portion of Video Content.

The invention provides for several arrangements of the classes of data. In one arrangement, all data classes are grouped on the same physical media such as a DVD. In another arrangement, the Video Content, Metadata, and the Index are broadcast, streamed, downloaded, or otherwise acquired from an external source and are stored on a Personal Video Recorder (PVR) unit. While these are the two most common arrangements, many other arrangements are possible. Any class of data could be stored on any type of device (including, but not limited to, set-top DVD players, set-top PVRs, personal computers, Internet servers, and Personal Digital Assistants) employing any type of computer storage (including, but not limited to, hard disk memory, RAM memory, flash memory, tape memory, and optical memory). With many types of physical media for storing digital content, and many actual and virtual playback devices and programs, there are multiple arrangements of the data classes that would provide for accessing all three classes of data.

The preferred embodiment includes all three classes of data stored on video DVD and is discussed in more detail below. Another embodiment includes all three classes of data broadcast, streamed, downloaded, or otherwise acquired from an external source and stored on a PVR unit. This embodiment is discussed in the Other Embodiments section.

The invention enables interactive video. Explicit product placement is when the name of a brand is featured and the brand is used/integrated into a video feature. Explicit product placement represents an important incremental revenue opportunity for a producer of video features and a high impact channel of advertising for companies wishing to promote their goods or services. There is a significant limitation, however, to the number of products, services, or locations that can be explicitly promoted before the entertainment value and artistic integrity of the video feature is compromised. The main reason for this limitation is the need for the video feature director to draw attention to the brand, product, or location within the storyline of the video feature without overtly making the viewer aware of the advertising. All other products used or contained within a video feature—as well as locations and the video feature score—remain anonymous and provide no means for incremental promotional revenue or advertising opportunities to their respective brand owners or benefactors. The invention provides video feature producers with the means to turn every product/location/music score contained within a video feature into an explicitly promoted and/or sponsored item without negatively impacting the entertainment value or artistic integrity of the video feature, and thereby generating a significant revenue opportunity for studios and a new channel of product promotion for advertisers. The sponsored item may be the scene itself, and the metadata may include any information about the scene, including, but not limited, to director's comments, information about how the scene was made, outtakes of the scene, information about the actors, etc. Interactive video provides paid sponsorship opportunities for any or all content placement in video features. When a viewer desires additional information about content heard or seen via a DVD, the viewer presses the Menu button on the DVD remote control. A screen is then displayed, which typically, but not necessarily, is a still image of the current scene in the video feature. Icons on the screen indicate items for which more information is available. The viewer navigates to the desired icon using the arrow buttons and presses the Enter button. Information then appears about the selected item. For example, in the 1995 motion picture “French Kiss” staring Meg Ryan and Kevin Kline, viewers might want to know what sunglasses Meg Ryan's character was wearing, and now they can by pressing menu on their remote control at the scene where Ms. Ryan is wearing the sunglasses and pointing to an icon overlaying the sunglasses.

Multiple information screens can be included throughout the video feature, and multiple portions of related content (metadata) can be promoted from each screen, which makes many promotional options available for video feature producers and provides a new channel of valuable information to the viewer.

Alternately, if a viewer prefers to watch a video feature continuously but still desires to view promotional content for certain scenes, a viewer can mark scenes for subsequent viewing of promotional content. The viewer can mark a scene by pressing the Enter button while a scene is playing. If the scene includes promotional content, then the scene's index number will be stored in one or more of the GPRMs. Later, the viewer can navigate to a content promotion menu to browse promotional content associated with each scene the viewer marked.

### FEATURES AND ADVANTAGES

One feature of the invention is that it can be implemented in set-top DVD players. As a result, it requires no new technology, no computer, and no Internet connections. It is compatible with the MPEG formats used in currently available DVD players.

Another feature of the invention is that it is activated simply by using the “menu and point” capabilities of all DVD remote controls.

Another feature of the invention is that it provides an interactive DVD system that includes both the video feature and the promotional content on the same DVD.

Another feature of the invention is continuity of viewing in that viewers can pause a video feature, find more information about items in the scene they are watching or a catalog for the entire video feature and, when ready, return to the point in the video feature to continue watching without having to begin the video feature again or manually search for the location where they were last viewing the video feature. For advertisers, this provides an entirely new channel of paid sponsorship for product placement in video features. The invention facilitates on-demand product promotion during video feature play back and removes the current risk of distracting product placement over saturation in a video feature while dramatically increasing product placement revenue.

Another feature of the invention is the ability to store or “bookmark” scenes with promotional content and then later view the promotional content for the stored scenes.

### BRIEF DESCRIPTION OF THE DRAWINGS

In the drawings, closely related figures and items have the same number but different alphabetic suffixes. Processes, states, statuses, and databases are named for their respective functions.

FIG. 1 is a flow chart of the initial splash screen logic.

FIG. 2A is a flow chart of the “Root” menu button interception logic.

FIG. 2B is a flow chart of the “Enter” menu button interception logic.

FIG. 3 is a flow chart of the “Menu” button interception logic.

FIG. 4A, FIG. 4B, and FIG. 4C are illustrations of the user interface experience.

FIG. 5 shows the high-level logical flow of the invention.

FIG. 6 shows the high-level components of the invention.

FIG. 7 is a flow chart of the navigation logic for viewer marked scenes.

### DETAILED DESCRIPTION OF THE INVENTION, INCLUDING THE PREFERRED EMBODIMENT

In the following detailed description of the invention, reference is made to the accompanying drawings, which form a part hereof, and in which are shown, by way of illustration, specific embodiments in which the invention may be practiced. It is to be understood that other embodiments may be used, and structural changes may be made, without departing from the scope of the present invention.

Terminology

The terminology and definitions of the prior art are not necessarily consistent with the terminology and definitions of the current invention. Where there is a conflict, the following definitions apply.

Author—One who engages in authoring.

Authoring—The integration of all the different components and media of a DVD according to the DVD specification It consists of combining the video, audio, stills, and subpictures that have been prepared as well as the design of the navigation path (see Subpicture) through this content.

Content Promotion Banner (CPB)—a screen display and menu containing detailed promotional information including, but not limited to, brand name, model number, shooting location, and/or biographical information.

Content Promotion Screen (CPS)—An interactive menu allowing the viewer to choose among various video feature content to obtain more detailed information on items of interest. More detailed information is included in the content promotion banner.

DVD—An optical-disc technology developed by the DVD Forum (formerly the DVD Consortium), a collection of 10 companies who contributed to the DVD standard and specification. There are six specified DVD varieties: DVD-ROM, DVD-Video, DVD-Audio, DVD-R (recordable), DVD-RAM (erasable), and DVD-RW.

Enter—Any key or function that is programmed into a DVD player to activate the currently selected button, which button may or may not be visible to the user. For example, on some set-top DVD players, pressing the ENTER key has the effect of activating the currently selected button; on other DVD players, pressing PLAY or OK key has the same effect.

General Purpose Registry Memory (GPRM)—One of 16 temporary storage locations available for use by the DVD author. Each register is 16 bits in length.

Menus—The DVD specification defines a certain number of menus available to the user through the press of a button on the remote control. These are known as system menus and are defined as: Title menu (“Title”), Root menu (“Menu”), Part-of-Title menu, Audio menu (“Language”), Angle menu, and Subpicture menu. Audio, Angle, and Subpicture menus reside within each VTS and can be used to change audio stream, video angle, and subpicture stream.

Navigation—In a DVD title, navigation includes the different viewing paths that viewers can select, such as menus and buttons, jumps between tracks, selection of languages, subtitles, or camera angles.

PGC—Program Chain. Similar to edit decision lists (EDLs) in video editing, PGCs consist of a sequence of various video clips and their playback order.

Promotional Content—Reference information regarding any scene content or audio track references for the purposes of promotion, advertising, or education.

Promotional Content Index Number—A number assigned to each scene and stored in a general purpose register (GPRM) within the DVD player by hidden, auto-activated buttons placed within the title being viewed.

Promotional Content Navigation Menu—A menu displayed on the content promotion screen.

Resume—Command to continue playing title at the point where pressing a menu button interrupted playback.

Root Menu—The Root menu resides in each Video Title Set and can be accessed with the Menu DVD remote button. The Root menu may contain choices for scene selection menus, audio menus, subtitle language selections, etc.

Set-top Player—A stand-alone DVD player that is not part of a computer. Connects directly to a TV or A/V receiver.

Subpicture—Simple pictures that are superimposed over the video or the still images. Subpictures can be created with regular graphics packages. They can have variable display sizes, but cannot exceed CCIR 601 picture dimensions (720×480 for NTSC-rate displays or 720×576 for PAL-rate displays) and have very limited color resolutions. Subpictures are used to design hot spots for menus, subtitles, or generally to enhance the DVD title's interface.

System Parameter Register Memory (SPRM)—One of 16 storage locations maintained by the DVD player to indicate player configuration, current chapter being viewed, etc.

Title—Titles usually describe an entire application placed on the DVD. A title includes one or more PGCs. Several titles can be placed on one disc.

Title Menu—The Title menu resides in the Video Manager and is used to access Titles on the disc. It may be accessed with the Title DVD remote button. The title menu may contain links to other menus on the disc. The title menu is sometimes referred to as the “top menu,” “system menu,” or “disc menu.”

Video Manager—The Video Manager is the top level unit that is initially accessed by the DVD player.

Video Title Set (VTS)—A group of related video titles having similar display format (e.g. standard screen or wide screen) or aspect ratios. There can be 99 titles per VTS.

Visual Cues (VC)—Markers and highlighters on the screen providing a visual indication to the viewer of which items of content from the scene include promotional content.

DVD Menus

DVD titles use menus as a way for viewers to navigate program content. Menus are comprised of a background image (either motion video or still frames), a subpicture overlay, a button highlight area, and sometimes even audio. If the DVD is set up for a 16:9 aspect ratio, three different sets of buttons and highlights must be created, one set for each possible display mode: wide-screen, letterbox, and pan/scan.

Menus can be designed in many different ways. A background image can be a motion video or a 24-bit color still. Choices displayed on-screen can be created as part of the background image to take advantage of the 24-bit color depth, or they can be created as subpicture overlays using the four possible colors. In either case, a button highlight is super-imposed on top and can represent the selection and action of a button. Using subpicture overlays provides the fastest navigation, but background images can be changed if greater color depth or image variety is desired.

A button highlight is defined as a rectangular region of the screen which can have a color and transparency for both a selection and an action. The highlight region can also key a highlight color over a predetermined color in a background image or subpicture. For example, a text selection may be in black, but when it is selected, the letters turn green. This allows the highlight region to color complex shapes, even though the highlight area is limited to x and y coordinates that define a box.

Whenever a system menu is accessed, the DVD player remembers where in the video stream it was playing and can then return to the same location after the viewer is finished looking at the menu or making a selection, such as a language or subpicture stream.

Although there is an area in the video title set and video manager for menus to be placed, all of the navigation, subpictures, and highlights are also available within the course of playback. In this sense, there is no conceptual difference between a video feature and a menu. The main difference is that by placing menus in the video manager and video title set, the viewer can quickly jump to them using the remote control.

System Registers and General Registers

DVD players are equipped with two kinds of memory registers, system (SPRM) and general (GPRM). The system registers are used by the DVD player to remember default settings such as language, aspect ratio, and parental rating level. These registers can be set by the viewer or by the DVD title in play.

The DVD specification requires DVD players to have sixteen 16-bit memory locations that can be used for basic computations or value storage. These are known as GPRMs and can only be addressed by the DVD in play. One example of the use of general parameters is the storage of values, such as the number of game lives.

Operation

The invention detects the differences in firmware functionality found in the variety of DVD players on the market. This is accomplished by presenting a branded “splash screen” immediately upon DVD insertion. The same functionality can be executed without the need to present the branded splash screen should the DVD author so choose. While the splash screen is being presented, a hidden button is executed, which attempts to store a known value into one of the 16 GPRMs available to the author. Upon the conclusion of the video clip, the selected register is examined to determine which of two modes to use. If the test is successful, the system will operate in “normal mode,” where the viewer is taken directly to the most relevant promotional content. Normal mode could also be called “scene mode.” In the event that the hidden button is not correctly interpreted, the system reverts to “chapter mode” where the viewer is directed to the promotional content of the last chapter point authored into the title. In chapter mode, the viewer must then use the promotional content navigation menu to page forward to the desired information.

Two GPRMs must be dedicated to the implementation of the invention with a third “work” register available during the activation of the promotional content menus. One of the dedicated registers is used as a “bitmapped” register to record various mode and navigation registers while the second is used to record the current promotional content index number.

The promotional content index number register is updated by auto-activated hidden buttons placed throughout the title to store a value into the dedicated index register. Upon menu activation, the invention logic first checks whether the viewer has elected to disable the promotional content feature. In that case, the normal DVD menu is displayed. Next, the promotional content mode switch is examined, and logic is executed to transfer directly to the relevant promotional content or to retrieve the current chapter number from the player's SPRMs and display the most relevant promotional content.

In either case, the content promotion screen contains navigation buttons that enable the viewer to take several actions, including, but not limited to, viewing director's comments, paging through the promotional content, requesting a help screen, viewing a catalog of available promotional content, calling the titles main menu, or resuming playing of the title from the point that viewing was interrupted using the standard DVD “resume” instruction.

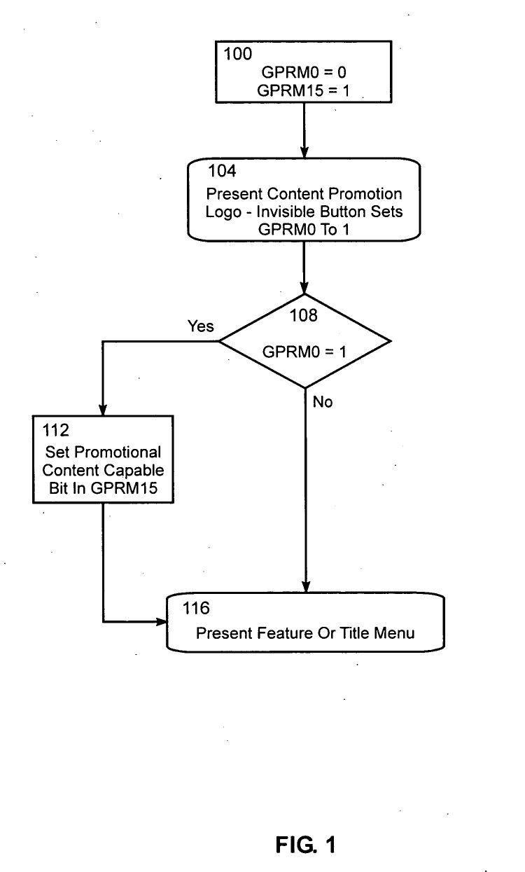

Referring now to FIG. 1. FIG. 1 is a flow chart of the initial splash screen logic, which describes the process of testing a set-top player for compatibility with the preferred embodiment of the present invention. In step 100, GPRM0=0 and GPRM15=1 and operation continues to step 104. In step 104, a content promotion logo is presented, an invisible button attempts to set GPRM0 to 1, and operation continues to step 108. DVD players that fully conform to the DVD specification will be able to recognize the invisible button and will successfully set GPRM0 to 1, and the invention will operate in normal mode. If a DVD player is not able to set GPRM0 to 1, then that player does not fully conform to the DVD specification, and the invention will operate in chapter mode. In step 108, the system tests whether GPRM0 has been set to 1. If GPRM0 has been set to 1, then operation proceeds to step 112, and if GPRM0 has not been set to 1, then operation proceeds to step 116. In step 112, GPRM15, the promotional content capable bit, is set to 1, and operation proceeds to step 116. In step 116, the title menu or title is presented, depending on how the DVD was authored.

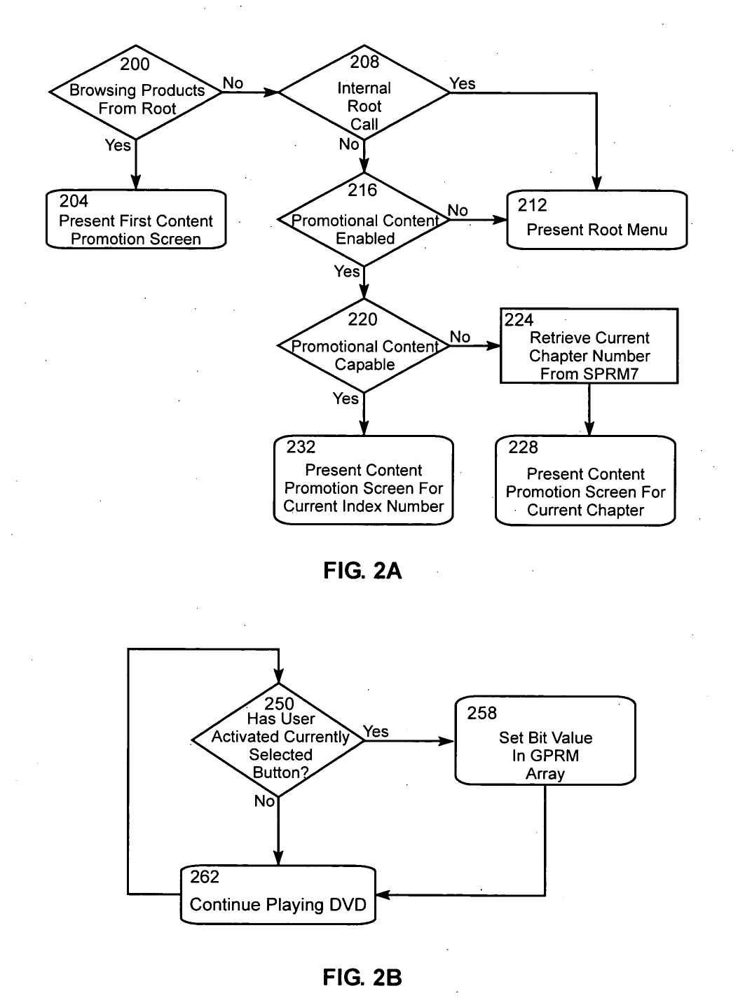

Referring now to FIG. 2A. FIG. 2A is a flow chart of the Root menu button interception logic. Operation begins at step 200, where the system tests whether products (or any content with associated metadata) are being browsed from the Root menu. If so, operation proceeds to step 204, where the system presents a first content promotion screen, otherwise, operation proceeds to step 208. In step 208, the system tests whether a root call is an internal root call. If so, operation proceeds to step 212, where the system displays the Root menu, and if not, operation proceeds to step 216. In step 216, the system tests whether a DVD is enabled for promotional content, that is, whether a viewer has disabled the promotional content functionality. If promotional content is not enabled, operation proceeds to step 212, and if promotional content is enabled, operation proceeds to step 220. In step 220, the system tests the extent to which a DVD player is capable of displaying the promotional content. If the DVD player is not fully capable of displaying the promotional content, the invention operates in chapter mode and operation proceeds to step 224, where the current chapter number is retrieved from SPRM7 and, in step 228, the system displays the content promotion screen for the current chapter. If the DVD player is fully capable of displaying the promotional content, then the invention operates in normal mode, and operation proceeds to step 232, where the system displays the content promotion screen for the current content promotion index number in the current scene.

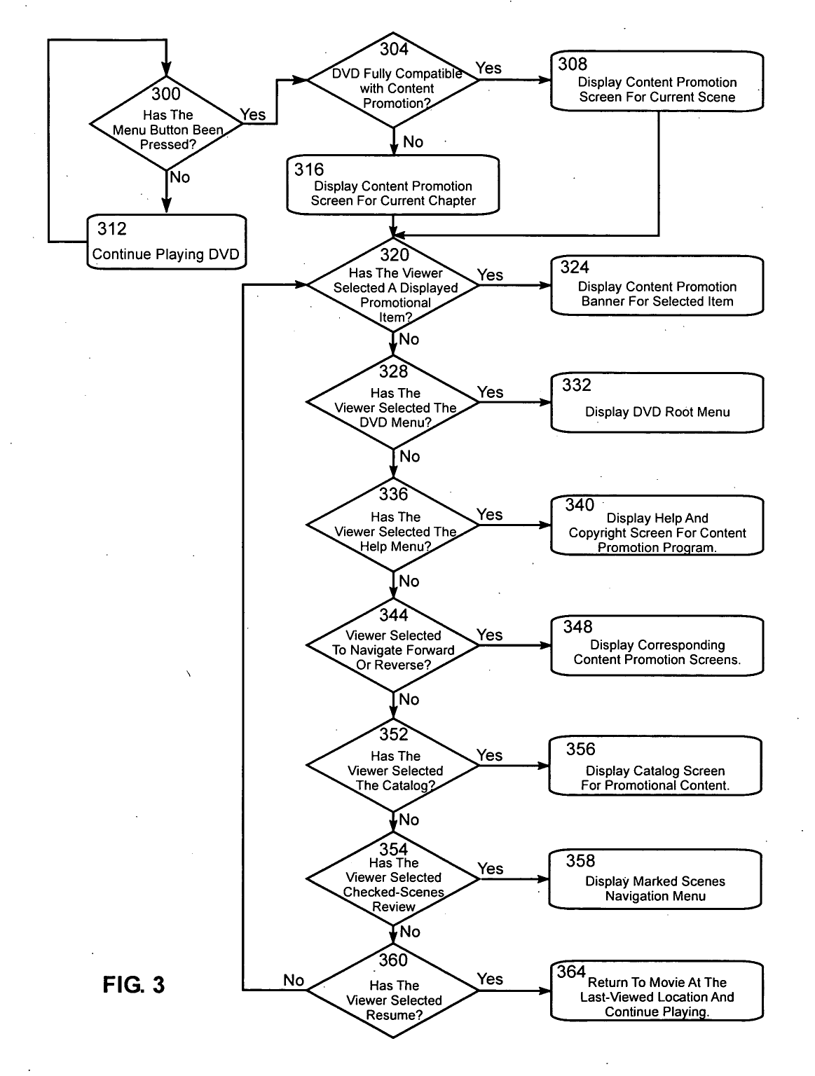

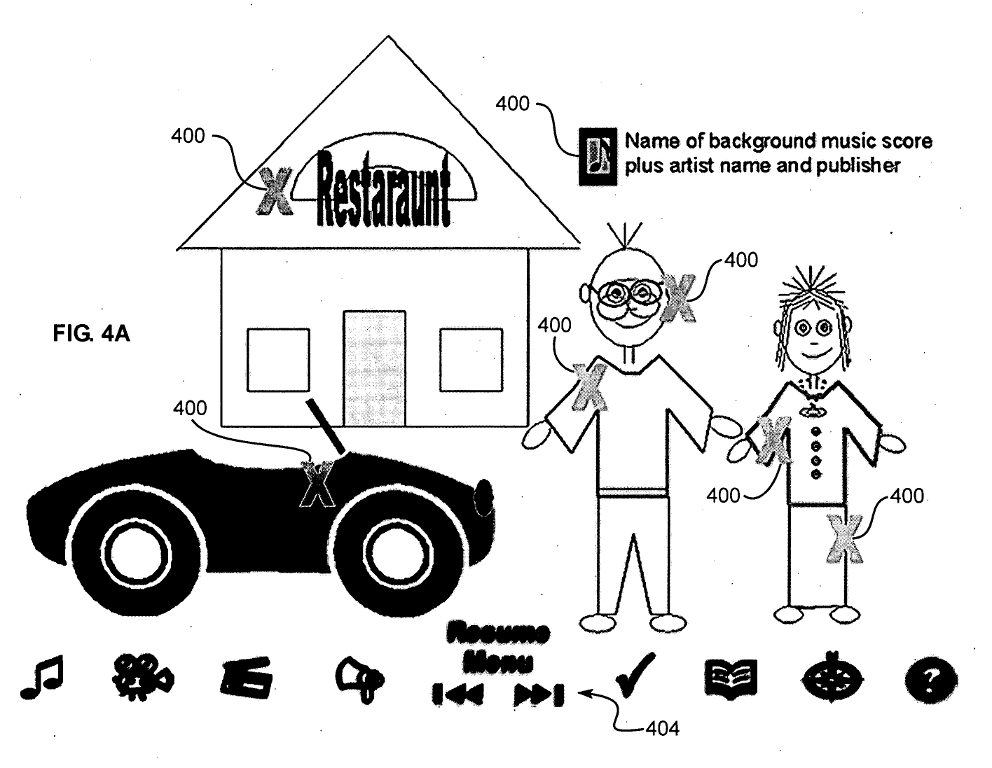

Referring now to FIG. 3. FIG. 3 is a flow chart of the user interface experience. Operation begins in step 300, where the system tests to see whether the menu button has been pressed. If not, operation continues to step 312, where the DVD player continues playing the video feature, and then operation continues to step 300. In step 300, if the menu button has been pressed, operation proceeds to step 304. In step 304, the system tests the extent to which a DVD player is capable of displaying the promotional content. If the DVD player is not fully capable of displaying the promotional content, the invention operates in chapter mode and operation proceeds to step 316, where the system displays the content promotion screen for the current chapter. If the DVD player is fully capable of displaying the promotional content, then the invention operates in normal mode and operation proceeds to step 308, where the system displays the content promotion screen for the current scene.

Continuing with FIG. 3. Operation then proceeds to step 320. The remaining steps involve displaying screens based on viewer input. If the viewer selects a displayed promotional item (step 320), then the system displays the content promotion banner for the selected item (step 324). If the viewer selects the DVD menu (step 328), then the system displays the DVD Root menu (step 332). If the viewer selects the help menu (step 336), then the system displays the help and copyright screen (step 340). If the viewer selects the forward or reverse navigation buttons (step 344), then the system displays the corresponding content promotion screens (step 348). If the viewers selects the catalog (step 352), then the system displays the catalog screen for all of the promotional content (step 356). If the viewer has marked scenes for later review (step 354), then the system displays the marked scenes menu (step 358). If the viewer selects the resume button (step 360), then the system returns to the video feature at the last-viewed location and continues playing the feature (step 364).

Between steps 320 and 360, other menus can be added as needed to provide additional functionality. For example, in the preferred embodiment, icons are used in the content promotion screen to aid navigation.
1) Activating a “musical note” icon calls up the music score associated with the scene or the music score for the entire video feature;
2) Activating a “video camera” icon calls up any video material related to the Content Promotion Screen. An example of this would be a “making of the scene” video or an addition informational video on the content of the scene. This video is typically played back within a window on the Content Promotion Screen (CPS) but not exclusively.
3) Activating a “clapper board” icon displays any alternative video sequences related to the current scene. An example would be “video out-takes” in a video feature.
4) Activating a “director's bullhorn” icon provides voice over playback for the material contained within the Content Promotion Screen.
5) Activating the left and right arrows navigates to the prior and next Content Promotion Screens
6) Activating the “Resume” icon exits the Content Promotion Screen and resumes playback of the video feature.
7) Activating the “Menu” icon accesses the root DVD menu on a DVD disc.
8) Activating the “check” icon allows the viewer to mark the scene so that it may be recalled by the viewer at a later stage for review.
9) Activating the “catalog” icon provides an index of all Content Promotion Screens including Content Promotion Banners contained on the DVD disc.
10) Activating the “compass” icon provides the viewer with the ability to navigate through all previously marked scenes sequentially or using a timeline.
11) Activating the “question mark” icon provides a help screen for the viewer and information about TellX.

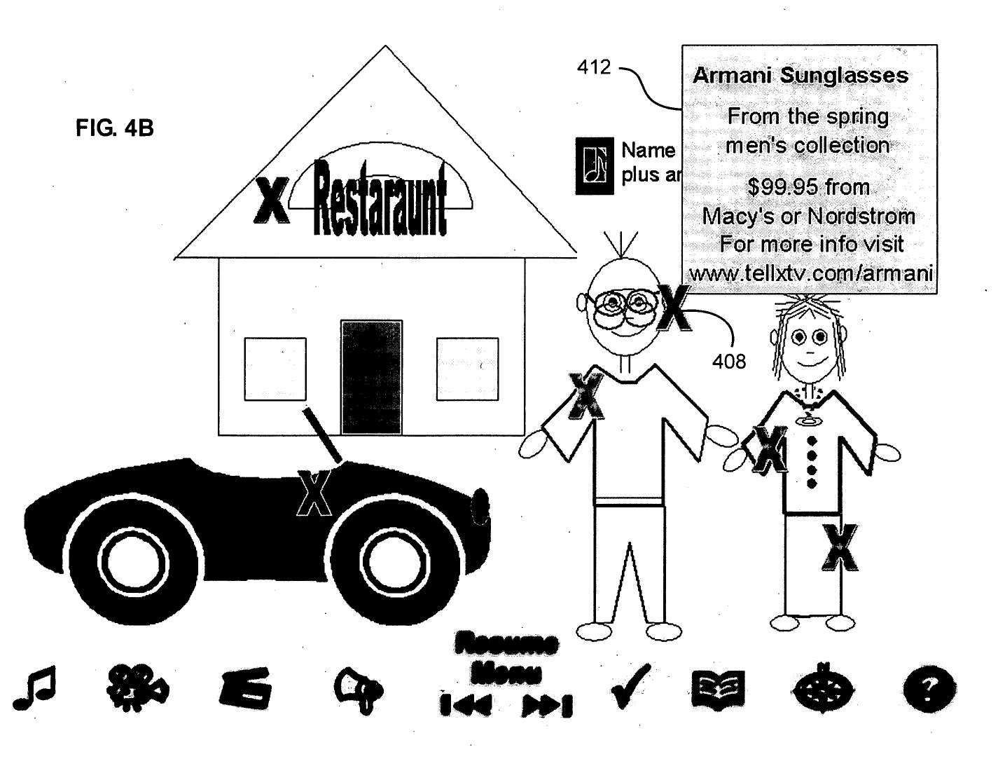

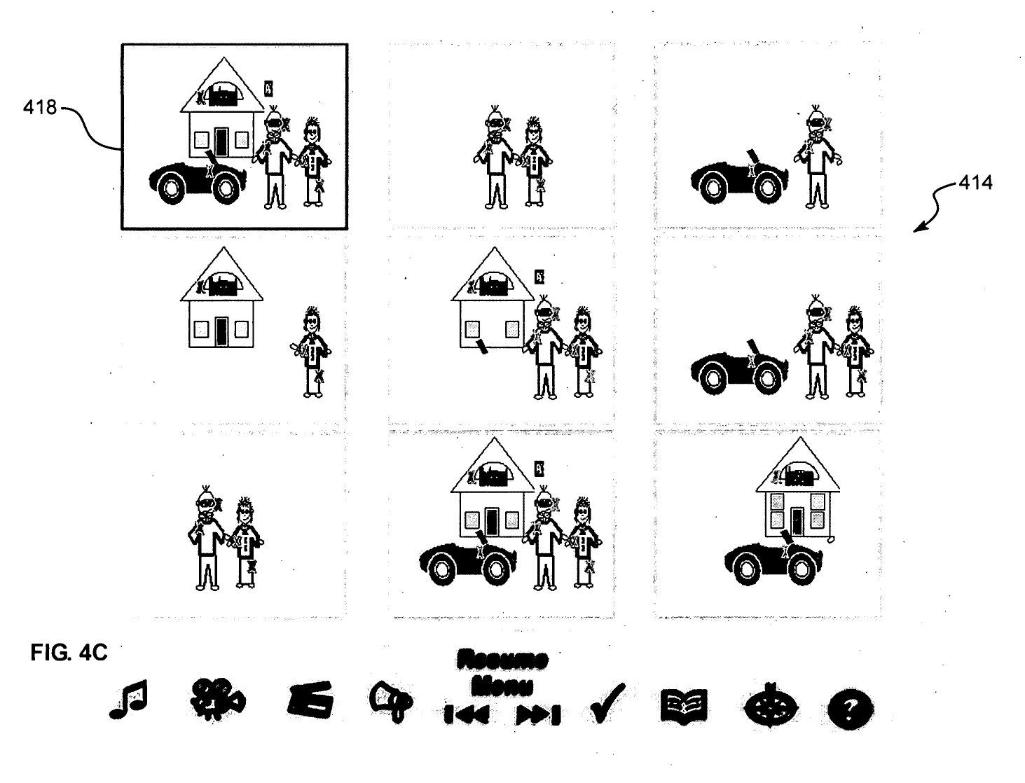

Referring now to FIG. 4A When the viewer selects the MENU button on the remote control, the specific content promotion screen for the current scene or chapter appears as a still image of part of the scene the viewer was watching. Visual cues, 400, appear next to all the video feature content that has promotional content associated with it, including such items as clothing, cars, background music score, jewelry, location, actors, anything heard, discussed, or viewed in the scene, or related to the scene, can be promoted using the present invention. A promotional content navigation menu, 404, also appears on the bottom of the screen to provide the viewer with options to access prior or subsequent content promotion screens, a catalog of all promotional content for the video feature, a help and copyright screen, the DVD Root menu, or resume playing the video feature. Other options can be added to the content navigation menu 404 as needed to provide additional functionality.

Referring now to FIG. 4B. This figure shows an example of what the invention may display when a viewer selects a visual cue. When visual cue 408, highlighting sunglasses, is selected, content promotion banner 412 appears providing promotional content about the sunglasses the man is wearing.

Referring now to FIG. 4C. If the viewer selects “catalog” from the on screen content promotion menu, a screen appears presenting miniaturized images, 414, of content promotion screens for the entire video feature. The last-viewed content promotion screen can be highlighted (418). Using the directional arrow keys on a remote control, a viewer can select any of the content promotion screens. By highlighting a scene and pressing ENTER on the remote control, the scene will increase to full size.

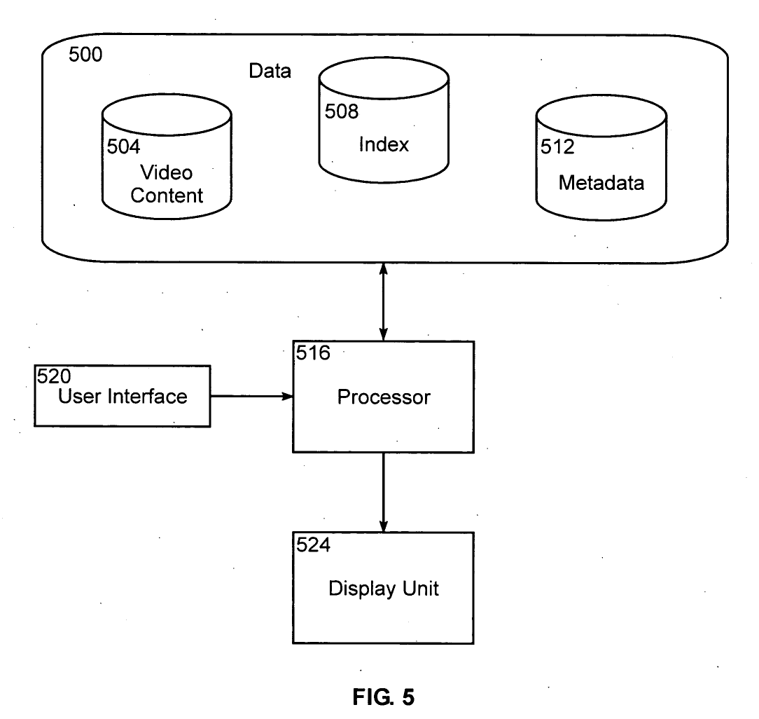

Referring now to FIG. 5, which shows three classes of data 500, including video content 504, index 508, and metadata 512. Data 500 are connected to and processed by processor 516. Processor 516 may include multiple processors. Video content 504 and metadata 512 are displayed by display unit 524, which can include multiple display units. Viewer interface 520 interconnects and interacts with processor 516. Processor 516 can be a set-top DVD player, set-top PVR, personal computer, Internet server, Personal Digital Assistants, or anything else cable of processing video content. Display unit 524 can be a television screen, computer screen, LCD display, or anything else capable of displaying video content. Viewer interface 520 can be a remote control, equivalent buttons on any set-top device, or anything else cable of communicating with processor 516.

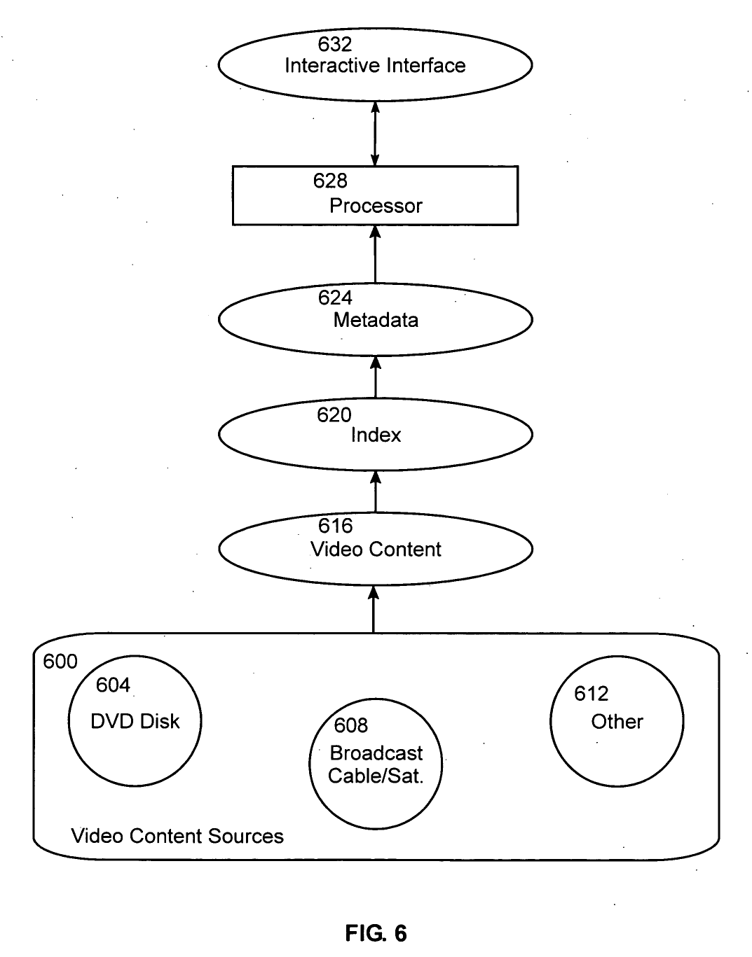

Referring now to FIG. 6. Video content sources 600 include one or more of DVDs 604, Broadcast/Cable/Satellite 608, and other 612. In other words, the video content source for the video content can be a DVD, broadcast television, cable television, satellite television, or any other source. Video content 616 is sourced from video content source 600, is indexed in index 620, is associated with metadata 624, is processed by one or more processors 628, and is displayed and controlled by one or more interactive interfaces 632. Interactive interface 632 combines the functionality of display unit 524 and viewer interface 520 discussed above.

An alternative to immediately viewing promotional content is marking scenes during playback for later viewing of promotional content. The invention has the capability to allow the viewer to “check,” “mark,” or “bookmark” a scene of interest in real-time or on-demand without pausing the video feature or interrupting in any way the playback of the video feature. Each scene has a unique “bit ID” which defaults to a value of “0” at the commencement of the video feature. When the viewer presses ENTER on a remote control, the value of the unique bit is assigned a value of “1”. This value flags a scene, i.e. registers a scene as marked among an array of all the scenes in the video feature. Each scene in the video feature with associated promotional content has a bit value which is contained within the General Purpose Registry of the DVD player. This array is volatile and stays in the memory of the player until the machine is turned off or the array is initialized (which will typically happen at the beginning of a video feature). Each scene that contains promotional content on the DVD has a unique bit variable assigned in the general purpose registry array, and it is this array which is accessed to determine which scenes should later be presented to the viewer for review and which scenes should be ignored.

When a promotional content enabled video feature is inserted into a set-top DVD player and playback of the video feature is initiated, the invention's logic code sets the array of scene bit values in the general purpose registry to “0”. Note that the first time the video feature is played back these values are already at “0” as the registry is volatile. As the viewer watches video playback and sees a scene of interest, the viewer presses ENTER on a remote control. Each scene has one or more logic buttons contained within it which have their display properties set to invisible. Pressing ENTER on the remote changes the button to “ACTIVE” and automatically displays the button to the viewer shaped as a check mark or other status mark. Additionally, the unique bit address for this scene in the GPRM is then set to “1”. The check mark button can be programmed to remain displayed for several seconds for visual confirmation that the scene has been marked for later review. The check mark can disappear after several seconds, or after the scene changes. The invention can also be programmed not to display any visual indication that a scene has been successfully marked.

By the end of the video feature, an array of GPRMs will have the values of “0” for scenes which were not marked and “1” for scenes which were marked. This array is the volatile database which is then navigated to provide the viewer with the information contained within each of the marked scenes.

Referring now to FIG. 2B. FIG. 2B is a flow chart of the ENTER menu button interception logic. Operation begins at step 250, where the system tests whether the ENTER menu button has been pressed. If not pressed, operation moves to step 262, where the DVD continues playing, and then operation returns to step 250. If the ENTER button has been pressed, then operation proceeds to step 258. In step 258, the current index number is stored in GPRM, and operation continues to step 262.

The invention also has the capability to enable the viewer to navigate marked scenes quickly. The need for sophisticated navigational capabilities is apparent when considering the number of scenes that a viewer may potentially mark in a two or three hour length video feature. When a large number of scenes have been checked for later review, manually stepping through every scene to get to the scene or scenes of interest would be cumbersome and impractical for a viewer. The invention provides a method of sequential navigation of the array of marked scenes or, alternatively, accelerated navigation of marked scenes.

There are multiple access points for a viewer to review marked scenes. At the end of the video feature, the option of reviewing marked scenes can be automatically displayed. Additionally, when the MENU button is pressed during video feature playback, the resulting content promotion screen can provide an icon which, when selected, gives access to the marked scenes menu. Alternatively, a viewer can review marked scenes by navigating through the DVD root menu.

There are several methods by which a viewer can navigate marked scenes of a DVD. One method is by sequentially stepping through each scene (i.e. one by one). Another method is by selecting a point on a virtual timeline that approximates how far into the video feature the checked scene is located. The invention will jump to the scene that is closest in its time code value (which is hard coded for each scene for each individual video feature) to the point on the timeline selected. Review of the marked scenes begins from the selected point forward.

In any method, the logic to review marked scenes is the same, with the invention marking the bit value for each scene in the GPRM (the array defined by the invention) and either displaying the promotional content corresponding to the selected scene, or skipping over it to the next appropriate promotional content. scene, based on the value of the bit in the array.

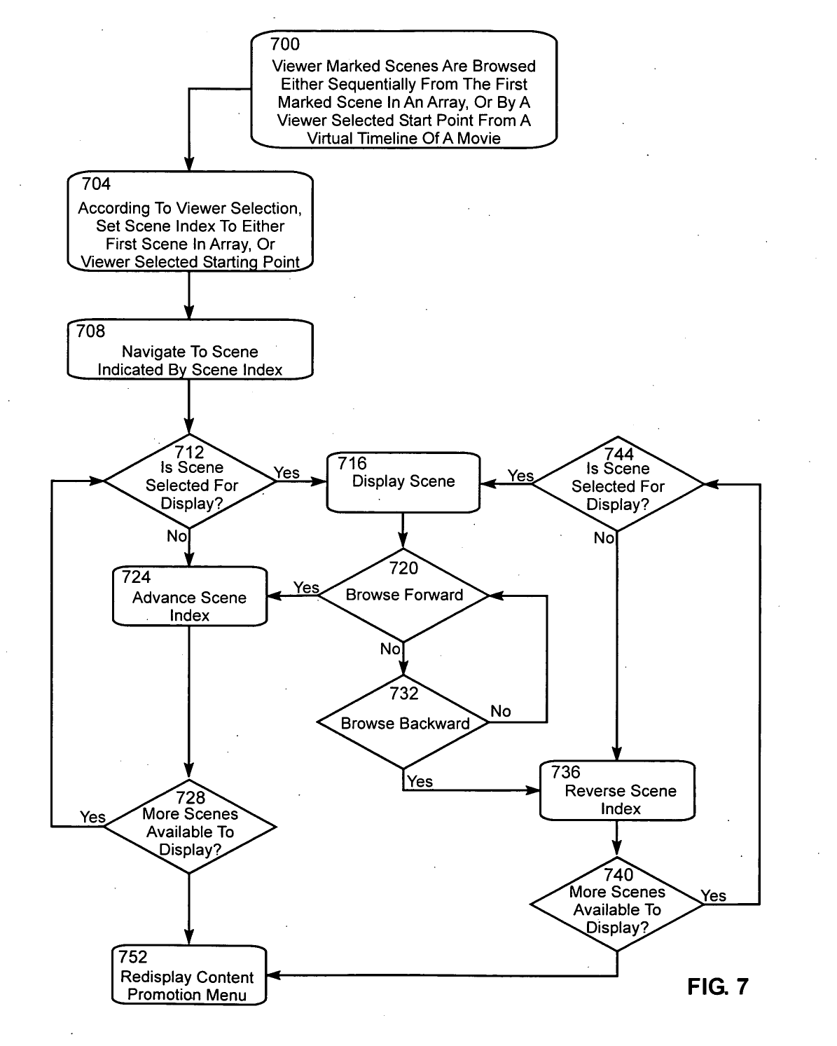

Referring now to FIG. 7. FIG. 7 is a flow chart of navigational logic for viewer marked scenes. Viewer marked scenes can be browsed either sequentially from the first marked scene of an array, or by a viewer selected starting point with the aid of a timeline, 700. The invention sets a scene index, according to viewer selection, to either the first scene in an array, or a viewer selected starting point, 704. In step 708, the invention navigates to a scene indicated by the scene index. In step 712, the invention determines whether the scene is selected for display. If the scene is selected for display, then the invention displays the scene, 716, if not, then the invention advances the scene index, 724. After displaying the scene, browsing forward, 720, will advance the scene index, and browsing backward, 732, will reverse the scene index, 736. If the viewer does not browse forward or backward, then the invention returns to step 720. After either advancing or reversing the scene index, the invention tests whether there are more scenes available to display, 728 and 740, and then whether a browsed scene is selected for display, 712 and 744. When there are no more scenes to display, then the invention redisplays the content promotion menu, 752.

### Other Embodiments

While the preferred embodiment of the invention is using the invention with a DVD, the invention can be adapted for use with any digital video media.

In another embodiment of the invention, the DVD authoring includes adding links to a website, which provides viewers with the ability to order many of the items featured on the DVD or to get additional information about any of the items or scenes. When a viewer plays the video feature on a PC or Internet-enabled set-top DVD player, using the remote control to point at the URL on the content promotion banner (CPB) automatically opens a window with content-specific website information displayed including, where appropriate, the capability for the viewer to order the item of interest online.

In another embodiment of the invention, the DVD authoring includes adding a searchable catalog which provides search menus for viewers to search from specific categories of items in which they may be interested. In this embodiment, a viewer inserts a DVD into a set-top player and calls up promotional or education information contained on the DVD from a main promotional content menu without having to browse the catalog or jump to a specific scene.

In another embodiment of the invention, viewers can turn on or off a visual cue from a master menu. The visual cue appears during the video feature in an inconspicuous location, such as the bottom right hand corner, to notify the viewer that the scene they are watching has promotional content associated with it.

In another embodiment of the invention, there is animation support for both content promotion banners (CPB) and content promotion screens (CPS). This functionality allows advertisers or content promoters to promote their products/services/locations using short video sequences within the screen “real estate” provided to them.

In another embodiment of the invention, each item being promoted optionally includes a short sound track that plays when the viewer selects the item from the content promotion screen (CPS).

In another embodiment of the invention, Internet transactions are supported without the need to call up a web browser by using the Internet connection capabilities of Internet-enabled DVD players and other devices such as PCTVs and multimedia entertainment centers.

In another embodiment of the invention, a search engine allows viewers to search for goods or services in real-time and pull up all video features in which the item or items were featured. A full list of video features containing the item is displayed and viewers can select short clips from scenes in which the item is featured.

Another embodiment of the invention includes a means for reporting viewer usage behavior information (viewing “impressions” as referred to in Internet advertising) back to advertisers or content promoters to show them how many viewers watched their promotional content and from which video features or content sources. This feature allows promotional content effectiveness performance to be monitored.

In another embodiment of the invention, advertisers can modify content in real time based on demographic information provided by the digital broadcast services the viewer subscribes to and/or viewer history data collected. An example of this approach is for a car manufacturer to display a content promotion banner for a higher cost luxury model version of a car over a lower cost standard model if it is determined that the household income of the viewer is within predetermined ranges.

In another embodiment of the invention, the Video Content, Metadata, and the Index are broadcast, streamed, downloaded, or otherwise acquired from an external source and are stored on a Personal Video Recorder (PVR) unit such as the ones produced by TiVO. Like DVD players, PVR units include the ability to pause and resume the display of Video Content. The PVR control logic is adapted to allow a viewer of any Video Content running on a PVR to, using the PVR remote control or equivalent buttons on the PVR set-top box, 1) enable the display of, 2) graphically navigate to, and 3) directly interrogate on-screen icons. The icons link to and activate the display of promotional content regarding scene content or audio track references for the purposes of promotion, advertising, education, entertainment, or otherwise.

It is to be understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

1. A method of providing an interactive video feature, the method comprising:
providing a video sequence for a viewer;
indexing objects in said video sequence with reference information;
overlaying icons on said indexed objects; and
enabling said icons to be selected by said viewer, whereby selecting one of said icons returns said reference information about said indexed object linked to said selected icon.

2. A method of providing promotional content for video content, the method comprising:
associating video content with promotional content and storing information about said association in an index; and
storing said index and said promotional content on a digital video medium containing said video content, thereby allowing a viewer of said video content to, using controls of a device for displaying said video content, enable the display of, graphically navigate to, and directly interrogate on-screen icons, whereby said icons link to and activate the display of said promotional content regarding scene content for the purposes of promotion, advertising, education, entertainment, or otherwise, wherein the display of said promotional content is initiated by intercepting a menu button command and returning a content promotion screen.

3. The method of claim 2, wherein said digital video medium is a DVD.

4. The method of claim 2, wherein said digital video medium is a DVD, and said video content is stored on said DVD.

5. The method of claim 2, wherein said digital video medium is a digital medium of a personal video recorder.

6. The method of claim 2, wherein said digital video medium is a digital medium of a personal video recorder, and said video content is broadcast, streamed, downloaded, or otherwise acquired for display by said personal video recorder.

7. A content promotion article comprising:
a DVD containing video content, index data, and promotional content associated with said video content, said DVD authored such that said video content is divided into scenes with said promotional content associated with one or more of said scenes by said index data, wherein said DVD is operable to:
play said video content from a DVD player;
set a bit in general purpose registry memory of said DVD player that indicates the extent to which said DVD player is content promotion capable;
access a content promotion screen directly from video play by intercepting a menu button command from a DVD player control, wherein selecting Menu during said video play of a scene containing said associated promotional content pauses said video play and presents a viewer with said content promotion screen having viewer-selectable content promotion icons overlaying items from said scene, wherein selecting one of said content promotion icons returns an associated content promotion banner; and
resume said video play, upon viewer selection, at a location of said scene containing associated promotional content, where said video play was interrupted to access said content promotion screen.

8. The article of claim 7, wherein said DVD is further operable to automatically enable menu button access to content promotional screens.

9. The article of claim 7, wherein said DVD is further operable to enable a viewer to toggle menu button access to content promotional screens.

10. The article of claim 7, wherein said DVD is further operable to test the extent to which said DVD player is capable of displaying said promotional content from menu button access.

11. The article of claim 7, wherein said DVD is further operable to retrieve content promotion screens by chapter number for DVD players that are not capable of retrieving said content promotion screens by index number.

12. The article of claim 7, wherein said DVD is further operable to enable a viewer to navigate content promotion screens from a content promotion menu.

13. A system for providing video content and metadata associated with said video content in an index, said system comprising:
video content storage means for storing said video content;
metadata storage means for storing said metadata;
index storage means for storing said index;
processor means for receiving and processing said video content from said video content storage means, said metadata from said metadata storage means, and said index from said index storage means;
display means for receiving and displaying said video content and said metadata;
input means for communicating with said processor means how and when to display selected parts of or all of said video content and said metadata.

14. The system of claim 13, wherein said video content is selected from the group consisting of digitized video, broadcast television signal, and cable television signal.

15. The system of claim 13, wherein said video content storage means is selected from the group consisting of DVD, hard disk memory, RAM, flash memory, tape memory, and optical memory.

16. The system of claim 13, wherein said metadata storage means is selected from the group consisting of DVD, hard disk memory, RAM, flash memory, tape memory, and optical memory.

17. The system of claim 13, wherein said index storage means is selected from the group consisting of DVD, hard disk memory, RAM, flash memory, tape memory, and optical memory.

18. The system of claim 13, wherein said processor means is selected from the group consisting of set-top DVD player, DVD-enable computer, personal digital assistant, personal computer, Internet server.

19. The system of claim 13, wherein said display means is selected from the group consisting of television screen and computer screen.

20. The system of claim 13, wherein said input means is selected from the group consisting of DVD remote control, DVD set-top box control, and computer input device.

21. The system of claim 13, wherein said metadata and said index are stored on a DVD.

22. The system of claim 13, wherein said metadata and said index are stored in a personal video recorder.

23. The system of claim 13, wherein said metadata and said index are broadcast or streamed from an external source.

24. A method of providing promotional content for video content, said method comprising:
associating video content with promotional content and storing information about said association in an index;
storing said index and said promotional content on a digital video medium containing said video content
enabling a viewer to mark scenes, having indexed promotional content, without interrupting play of said video content;
displaying marked scenes such that icons overlay indexed objects, wherein selecting an icon returns information about a selected object.

25. A content promotion article comprising:
a DVD containing video content, index data, and promotional content associated with said video content, said DVD authored such that said video content is divided into scenes with said promotional content associated with one or more of said scenes by said index data, wherein said DVD is operable to:
play said video content from a DVD player;
enable a viewer to mark said scenes, having said promotional content, by activating a currently selected button, wherein marking said scenes stores viewer selections in general parameter register memory of said DVD player, thereby providing uninterrupted viewing;
create an index of marked scenes for later review of said promotional content associated with said marked scenes; and
provide access to a content promotion menu for accessing content promotion screens, and marked content promotion screens, wherein said content promotion screens have viewer-selectable content promotion icons overlaying items from a scene, wherein selecting a content promotion icon returns an associated content promotion banner.

26. The article of claim 25, wherein said DVD is further operable to display visual cues during video play, wherein said visual cues indicate that a currently playing scene contains said promotional content, thereby indicating that said currently playing scene is capable of being marked by a viewer for later review.

27. The article of claim 25, wherein said DVD is further operable to enable a viewer to toggle whether said scenes display visual cues indicating that a currently playing scene contains said promotional content.

28. The article of claim 25, wherein said DVD is further operable to provide a timeline of marked scenes for viewer to access for navigation of marked scenes.

29. The article of claim 25, wherein said DVD is further operable to provide an array of marked scenes for a viewer to review sequentially.
